(19) United States
(12) Patent Application Publication
(10) Pub. No.: US 2022/0122111 A1
(43) Pub. Date: Apr. 21, 2022

(54) COMPUTATION SERVER SYSTEM AND METHOD FOR USER-SPECIFIC PROCESSING

(71) Applicant: NURTURE FINANCIAL SERVICES, LLC, Boston, MA (US)

(72) Inventors: Zahra Ayub, Boston, MA (US); Syed Shahrukh Tauqir, Boston, MA (US)

(73) Assignee: NURTURE FINANCIAL SERVICES, LLC, Boston, MA (US)

(21) Appl. No.: 17/504,222

(22) Filed: Oct. 18, 2021

Related U.S. Application Data
(60) Provisional application No. 63/093,506, filed on Oct. 19, 2020.

(51) Int. Cl. G06Q 30/02; G06Q 40/06

(52) U.S. Cl. CPC G06Q 30/0216; G06Q 30/0283; G06Q 40/06

(57) ABSTRACT

Provided herein are systems and methods using real-time electronic data associated with a user account to modulate merchant discount data specific to a user.

### CROSS-REFERENCE TO RELATED APPLICATIONS

This application claims priority to U.S. Provisional Application Ser. No. 63/093,506, filed Oct. 19, 2020, which is hereby incorporated by reference in its entirety.

### BACKGROUND

Investments are good for economic growth and for personal financial stability. Investments foster economic growth by helping firms meet future demand, increasing productivity of capital, and decreasing the cost of borrowing. Investments offer personal financial stability by helping individuals grow their wealth over time, save for retirement, and mitigate financial loss in the case of emergency.

Despite these and other benefits of investing, large portions of the global population do not actively invest. Existing investment models have individuals set aside money to invest, decreasing the amount of money individuals have available to spend. Though existing models assume that money set aside increases in value over time, the set-aside requirement leaves many people unable to participate in investing. Accordingly, there is a need for expanded access to investing.

### FIELD OF DISCLOSURE

The field of the disclosure relates, generally, to systems and methods for using electronic data associated with a user account to modulate merchant discount data in a user specific manner.

### SUMMARY

According to one aspect of the present disclosure, a method can include identifying, by a computation server, an item for a user; accessing, by the computation server, a consumer investment portfolio and a portfolio database associated with a consumer account of the user; determining, by the computation server, an offset amount to be applied to a price of the item by analyzing, in real-time, a performance of the consumer investment portfolio associated with the respective consumer account of the user; generating, by the computation server, an updated price of the item for the user by applying the offset amount to the price of the item, the updated price of the item unique to the performance of the consumer investment portfolio; and transferring, by a payment gateway server, a payment from the consumer account to a merchant account if the user purchases the item.

In some embodiments, the method can further include detecting, by the computation server, a change in the performance of the consumer investment portfolio prior to payment from the user; determining, by the computation server, a second offset amount based on the change in the performance; and based on the determining, generating, by the computation server, a second updated price of the item for the user by applying the second offset amount to the price of the item, the second updated price unique to the change in performance of the consumer investment portfolio. In some embodiments, the method can further include, accessing, by the computation server, a second consumer investment portfolio and a second portfolio database associated with a second consumer account of a second user; determining, by the computation server, a second offset amount to be applied to the price of the item by analyzing, in real-time, a performance of the second consumer investment portfolio associated with the second consumer account; and generating, by the computation server, a second updated price of the item for the second user by applying the second offset amount to the price of the item, the second updated price of the item unique to the performance of the second consumer investment portfolio, the second updated price of the item different than the first updated price of the item. In some embodiments, determining, by the computation server, the offset amount to be applied to the price of the item by analyzing, in real-time, the performance of the consumer investment portfolio associated with the respective consumer account can include: assigning, by the computation server, an invested principal pegged value to the respective consumer account; computing, by the computation server, a loss on the invested principal pegged value; assigning, by the computation server, a discount value equal to the loss on the invested principal pegged value; comparing the discount value to a discount threshold for each product and service listed in an investment-based merchant pricing platform; and applying the discount value at most up to the discount threshold for each product and service, which is stored on a products and services database. In some embodiments, determining, by the computation server, the offset amount to be applied to the price of the item by analyzing, in real-time, the performance of the consumer investment portfolio associated with the respective consumer account can include: assigning, by the computation server, an enhanced principal pegged value to the respective consumer account; computing, by the computation server, a loss on the enhanced principal pegged value; assigning, by the computation server, a discount value equal to the loss on the enhanced principal pegged value; comparing the discount value to the discount threshold for each product and service listed in the investment-based merchant pricing platform; and applying the discount value at most up to the discount threshold for each product and service, which is stored on the products and services database. In some embodiments, the method can further include the computation server updating the price of one or more products or services listed on the investment-based merchant pricing platform comprises; displaying the discount value equal to the loss on the enhanced principal pegged value or the discount value equal to the loss on the invested principal pegged value on a graphical user interface; and displaying the updated price of one or more products or services listed on the investment-based merchant pricing platform that does not exceed the discount threshold for each product and service, which is stored on the products and services database.

According to another aspect of the present disclosure, a system can include a computation server configured to perform as follows: identifying an item for a user; accessing a consumer investment portfolio and a portfolio database associated with a respective consumer account of the user; connecting to an index fund server that is linked to an electronic trading platform; and determining an offset amount to be applied to a price of the item by analyzing, in real-time, a performance of the consumer investment portfolio associated with the respective consumer account; generating an updated price of the item for the user by applying the offset amount to the price of the item, the updated price of the item unique to the performance of the consumer investment portfolio; and a payment gateway server transferring a payment from a consumer account to a merchant account if the user purchases the item.

In some embodiments, the system can further include transferring a payment from a consumer account to a merchant account if a consumer makes a purchase on an investment-based merchant pricing platform. In some embodiments, the investment-based merchant pricing platform can contain an online marketplace server, an offline merchant server, one or more point of sale (POS) terminals, and a products and services database. In some embodiments, determining the offset amount to be applied to the price of the item by analyzing, in real-time, the performance of the consumer investment portfolio associated with the respective consumer account can include: the computation server, connecting to the portfolio database; assigning an invested principal pegged value to the respective consumer account; computing a loss on the invested principal pegged value; assigning, by the computation server, a discount value equal to the loss on the invested principal pegged value; comparing the discount value to a discount threshold for each product and service listed in the investment-based merchant pricing platform; and applying the discount value at most up to the discount threshold for each product and service, which is stored on the products and services database. In some embodiments, determining, by the computation server, the offset amount to be applied to the price of the item by analyzing, in real-time, the performance of the consumer investment portfolio associated with the respective consumer account can include: the computation server, connecting to the portfolio database; assigning an enhanced principal pegged value to the respective consumer account; computing a loss on the enhanced principal pegged value; assigning a discount value equal to the loss on the enhanced principal pegged value; comparing the discount value to the discount threshold for each product and service listed in the investment-based merchant pricing platform; and applying the discount value at most up to the discount threshold for each product and service, which is stored on the products and services database. In some embodiments, the system can further include the computation server updating the price of one or more products or services listed on the investment-based merchant pricing platform can include; displaying the offset amount to be applied to the price of an item on a graphical user interface, and displaying the updated price of one or more products or services that does not exceed a pricing and discount threshold for each product or service, which is stored on the products and services database.

For purposes of summarizing, certain aspects, advantages, and novel features have been described herein. It is to be understood that not all such advantages can be achieved in accordance with any one particular embodiment. Thus, the disclosed subject matter can be embodied or carried out in a manner that achieves or optimizes one advantage or group of advantages without achieving all advantages as can be taught or suggested herein.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is a schematic diagram of a system using electronic data associated with a user account to modulate merchant discount data in a user specific manner.

FIG. 2 is a flowchart of process LTD in accordance with certain embodiments.

FIG. 3 is a flowchart of process PPP in accordance with certain embodiments.

FIG. 4 is an example of difference in functional output between two processes LTD and PPP.

The drawings are not necessarily to scale, or inclusive of all elements of a system, emphasis instead generally being placed upon illustrating the concepts, structures, and techniques sought to be protected herein.

### DETAILED DESCRIPTION

The following detailed description is merely exemplary in nature and is not intended to limit the disclosure or the applications of its use.

The terminology used in the present disclosure is for the purpose of describing particular exemplary embodiments only and is not intended to be limiting. As used in the description of the embodiments of the disclosure and the appended claims, the singular forms “a,” “an,” and “the” are intended to include the plural forms as well, unless the context clearly indicates otherwise.

The term “and/or,” as used herein, refers to and encompasses any and all possible combinations of one or more of the associated listed items.

Embodiments of the present disclosure provide systems and methods for using electronic data associated with a user account to modulate merchant discount data in a user specific manner. In some embodiments, the system and methods of the present disclose can obtain and store data associated with a consumer account of a user in real-time or near-real time. Data associated with a consumer account of a user can be, for example, a consumer investment portfolio associated with the consumer account of the user. In some embodiments, the system 100 can include a consumer communication device 102 configured as an online account-based system (e wallet, for example) as a consumer account. In some embodiments, the online account-based system can be associated with the consumer investment portfolio of the user and can connect to an investment-based merchant pricing platform 110. In some embodiments, the system 100 can also include an index fund server 124 in communication with a computation server 122. In some embodiments, the index fund server 124 can be linked to an electronic trading platform. In some embodiments, index fund server 124 can represent index funds and or investment portfolios in which a consumer can invest savings and/or income through the consumer's account using, for example, the user's communication device 102. In some embodiments, the computation server 122 can execute processes that modulate the price of products and services to match the loss fluctuation on the user's investments in real time, near real-time, by determined intervals. In some embodiments, the computation server 122 can monitor a user's investments, in real-time, near real-time, or in determined intervals, and can apply earnings on those investments to purchases. In some embodiments, the computation server 122 can transfer a payment (funds) from a consumer account to a merchant account if the consumer purchases an item. In some embodiments, the computation server 122 be connected to a merchant bank account to facilitate transfer of funds from a consumer during a consumer transaction. In still other embodiments, the system 100 can be configured to offer loss management features to a user.

Available investing methods assume individuals will be able to defer consumption and reduce expenses, which assumption leaves large portions of the population unable to invest. Globally, many people spend their income as they earn it, which prevents individuals from saving money to invest. Nearly 70% of Americans, for example, have less than $1,000 saved. As such, a large segment of the global population does not have surplus funds to invest. At the same time, the average American consumer spent 7% more year over year (yoy) from 2017 to 2019 due to the ease of online shopping. Heightened consumerism creates a competitive landscape among merchants who are forced to offer heavy discounts, free delivery and returns, and other services in order to gain maximum market share. These attractive offerings make it harder for a common person to cut down expenses and save money. For merchants, even with high volumes, the overall profitability declines due to flat discount offerings to a mass population.

Although existing marketing technologies generate and collect data about consumers for merchants, inventors have determined that there are significant limitations, inefficiencies, and problems with existing methods. Users generate data when interacting with a plurality of platforms. However, systems for organizing and using that data are lacking. A user's data generated in association with activity on one platform is not coupled with data generated on another platform. For example, users generate data associated with an investment portfolio, however, merchants do not have access to user-specific portfolio performance data. Instead, many discounts or promotions that merchants send to users are based on email click-rate data, general demographic data, or user activity. These factors lack specificity and thus entail inefficiencies.

Accordingly, some embodiments of the present disclosure provide systems and methods for using electronic data associated with a user account to modulate merchant discount data specific to a user in real-time or near real-time, at determined intervals. Determined intervals can be system specific.

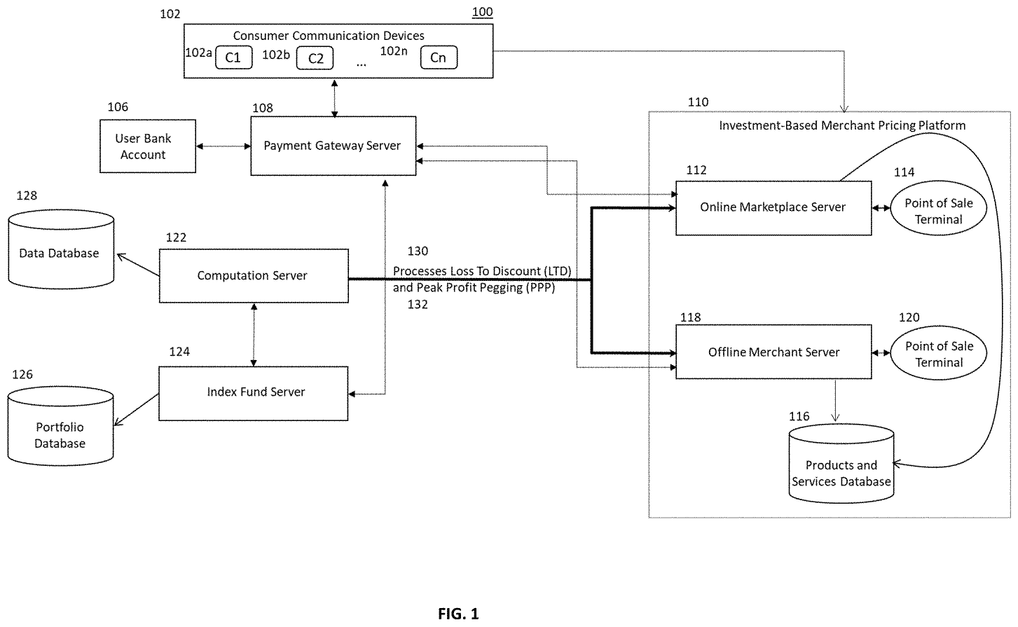

FIG. 1 is a schematic diagram of a system 100 using electronic data associated with a user account to modulate merchant discount data in a user specific manner, according to example embodiments. Electronic data can be, for example, any data related to a consumer account described herein. For example, electronic data can be investment portfolio performance data. In some embodiments, the system 100 can use electronic data associated with a user account to modulate merchant discount data in a user specific manner in real-time or near real-time. In some embodiments, the system 100 can use electronic data associated with a user account to modulate merchant discount data in a user specific manner in real-time or near real-time when the user executes a command. In some embodiments, the system 100 can use electronic data associated with a user account to modulate merchant discount data in a user specific manner in real-time or near-real time at determined intervals.

In some embodiments, determined intervals can be about every 1, 2, 3, 4, 5, 6, 7, 8, 9, 10, 15, 20, 25, 30, 35, 40, 45, 50, 55, 60 seconds, or any range or value between. In some embodiments, determined intervals can be about every 1, 2, 3, 4, 5, 6, 7, 8, 9, 10, 15, 20, 25, 30, 35, 40, 45, 50, 55, 60 minutes, or any range or value between. In some embodiments, determined intervals can be about every 1, 2, 3, 4, 5, 6, 7, 8, 9, 10, 11, 12, 13, 14, 15, 16, 17, 18, 19, 20, 21, 22, 23, 24 hours, or any range or value between. In some embodiments, determined intervals can be about every 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31 days, or any range or value between. In some embodiments, determined intervals can be about every month. In some embodiments, determined intervals can be when a user initiates a command.

The system 100 can include consumer communication devices 102 operatively coupled to a computer program product (not shown) having a computer-usable medium. Consumer communication devices 102 can be operated by a user. The computer-usable medium can be, for example, an online account-based system. As used herein, the terms “consumer” or “user” can be used interchangeably and refer to a user of the system 100 or recipient of goods, services, promotions, or the like provided by the system 100. Consumers can include, without limitation, individuals, groups of individuals, corporations, and the like. In some embodiments, the consumer communication devices 102 can include C1 102a, C2 102b, and Cn 102n. Each of C1 102a, C2 102b, and Cn 102n can include a processor and storage medium (not shown). In some embodiments, devices C1 102a, C2 102b, and Cn 102n can be representative of communications devices supporting near field communication (NFC) transmission. Examples include, but are not limited to, mobile phones, laptop computers, personal digital assistants (PDA), portable multimedia players, desktops, multiprocessor systems, microprocessor-based systems, programmable consumer electronics, telephony systems, distributed computing environments, set top boxes, and so on. In some embodiments, devices C1 102a, C2 102b, and Cn 102n can further include a consumer interface console, such as a touch screen monitor (not shown), to allow the consumer to preset various system parameters. Consumer defined system parameters can include, but are not limited to, investment metrics, payment information, investment variables, and external application accessibility.

In some embodiments, consumer account can be an online account-based system. can In some embodiments, consumer communication devices 102 can be configured as an online account-based system (e wallet) that can include multiple elements displayed on a graphical user interface (GUI) (not shown) connected over a data network (represented by all arrows in FIG. 1). In some embodiments, the elements of the online account-based system can include, but are not limited to, a computation server 122, a data database 128, a portfolio database 126, a payment gateway server (PGS) 108, an investment-based merchant pricing platform 110, a products and services database 116, and an index fund server 124.

In some embodiments, the system 100 can include a data database 128. In some embodiments, data database 128 can store information such as, but not limited to, consumer investments, payment transactions, applicable or availed discounts, earned profits, and other records associated with the consumer account of the user (e.g., respective user's online account-based system). In some embodiments, the information from the data database 128 can be accessed by the user through a computation server 122 (discussed below) over data network through network connections such as wide area network (WAN) (represented by all arrows in FIG. 1). As one of ordinary skill in the art would appreciate, the data database 128 can include any type of storage device or storage medium such as hard disks, cloud storage, CD-ROMs, flash memory, DRAM and can also include a collection of devices (e.g., Redundant Array of Independent Disks (“RAID”)). In some embodiments, the user can avail a discount and the data database 128 can store that information associated with the consumer account of the user, which, again, can be the user's respective online account-based system. In some embodiments, the computation server 122 can access information from data database 128 that the user's loss on investment has been supplemented and hence no further discount is needed. In some embodiments, the data database 128 can store the transaction history of a user and the computation server 122 can access this transaction history information to recommend similar products to the user for future purchases. In some embodiments, the data database 128 can store a user's savings goals.

In some embodiments, the system 100 can include portfolio database 126. In some embodiments, the portfolio database 126 can store electronic data associated with a consumer account of a user. In some embodiments, the electronic data can include consumer investment portfolio i.e., consumer investment performance data. In other words, in some embodiments the portfolio database 126 can store investment performance data for a consumer investment portfolio. In some embodiments, the portfolio database 126 can store electronic data of investment accounts including index fund accounts, individual investment funds, and collective investment funds. In some embodiments, the portfolio database 126 can store information regarding the user's chosen investment schemes, such as, social conscious funds, exchange-traded funds (ETF), mutual funds, fund of funds (FOF), pre-constructed portfolios, and so on. In some embodiments, the information from the portfolio database 126 can be accessed over data network by the index fund server 124 through network connections such as wide area network (WAN) (represented by all arrows in FIG. 1). In some embodiments, the loss management features (such as computing as offset amount to be applied to the price of an item, process LTD 130, process PPP 132, loan facilitation, and other features discussed herein) can be utilized by a user when the computation server 122 reaches out to the index fund server 124 to retrieve the data from the portfolio database 126 and correspondingly modulate the price of products. As one of ordinary skill in the art would appreciate, in some embodiments, the portfolio database 126 can include any type of storage device or storage medium such as hard disks, cloud storage, CD-ROMs, flash memory, DRAM and can also include a collection of devices (e.g., Redundant Array of Independent Disks (“RAID”)).

In some embodiments, the system 100 can include a validation server (not shown), In some embodiments, a validation server (not shown) can mediate user access to data for security. In some embodiments, the validation server can serve a user's request to information related to the user's investments after validating and authenticating the user. After validating and authenticating the user, the validation server can provide data to the user accordingly. Additionally, in some embodiments, the validation server can introduce an added layer of security for all transactions that take place. In some embodiments, the validation server can also help in making the system 100 performance efficient and cost effective. In some embodiments, in the system 100, any flow of information to and from devices C1 102a, C2 102b, and Cn 102n can happen through validation server. Similarly, in some embodiments, a validation server can also control information flow between servers (e.g., computation server 122 and online marketplace server 112) and servers and databases (e.g., computation server 122 and products and services database 116) for the above-mentioned security benefits.

In some embodiments, the system 100 can include a user payment gateway (not shown) including, but not limited to, application program interfaces (API) and online account-based systems. In some embodiments, consumer account can include connection to user payment gateway. Online account-based systems, such as but not limited to those available from PayPal and Google, allow consumers to securely transfer electronic funds from numerous financial accounts. In some embodiments, a consumer can transmit electronic funds through their online accounts with help of a banking API (BAPI) using a consumer account accessed by one or more consumer devices C1 102a, C2 102b, and Cn 102n. In some embodiments, the API can include specifications for routines, data structures, object classes, and variables. Such interfaces are generally well known. In some embodiments, the user payment gateway can be connected to a user bank account 106.

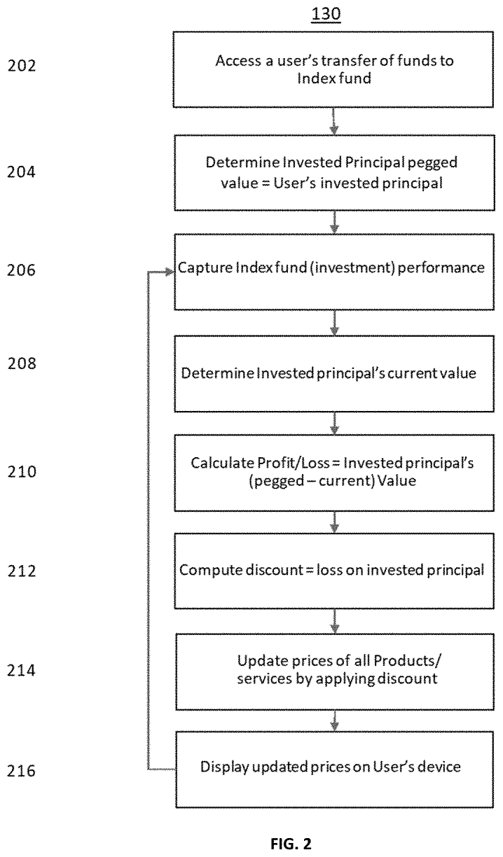

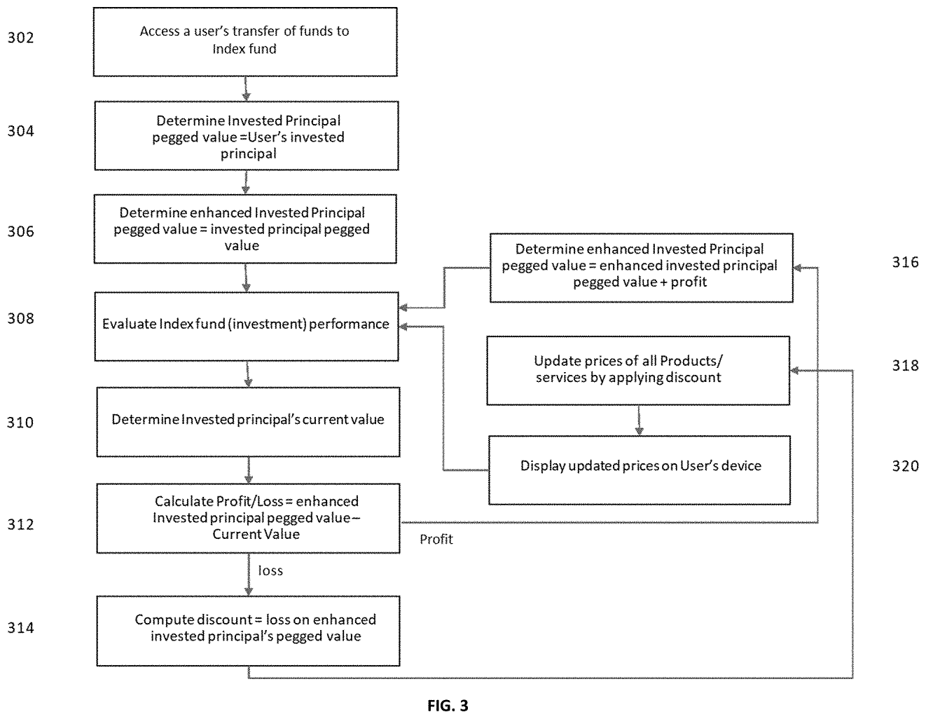

In some embodiments, the system 100 can include payment gateway server (PGS) 108, which can further include an API having a set of components, routines, protocols and tools for communicating with various applications [e.g., computing as offset amount to be applied to the price of an item, process loss to discount (LTD) 130 and peak profit pegging (PPP) 132 discussed in FIG. 2-3] over data network (represented by all arrows in FIG. 1).

In some embodiments, the system 100 can include an investment-based merchant pricing platform 110 which can list all categories of products and services by connecting to an online marketplace server 112, point of sale (POS) terminals 114, 120, PGS 108, an offline merchant server 118, and a products and services database 116. In some embodiments, the online marketplace server 112 can include ecommerce websites (not shown), a web-based operating system and a processor (not shown) for hosting web pages, and a POS terminal 114. In some embodiments, the POS terminal 114 can be configured to support online transactions such as electronic transfer of funds through a banking API (BAPI) or online account-based systems such as, but not limited to, PayPal, Google Wallet and so on. In some embodiments, the online marketplace server 112 can be communicatively linked, such as through a Wide Area Network (WAN) (represented by arrows in FIG. 1), to a payment gateway server 108.

It is worthwhile to note that, in some embodiments, the system 100 can obtain data and modulate prices online or offline. Online obtaining means that the system receives a real-time message that carries a command, and then executes the command in real-time or near real-time after obtaining the command. In some embodiments, for example, the system 100 can receive a command from a user device 102 to determine a unique, user specific discount for an item. The computation server 122 then can determine the offset amount to apply to the price of the item.

Offline obtaining means that the system synchronizes data regularly, and processes synchronized data offline after obtaining the data. For example, in some embodiments, the computation server 122 synchronizes the data at 6:00 am every day. When data is processed offline, stability of online system can be ensured, data processing complexity can be reduced, and reliability of a data processing result can be ensured.

In some embodiments, the offline merchant server 118 can be communicatively linked, such as through a Wide Area Network (WAN) (represented by arrows in FIG. 1), to a payment gateway server 108. In some embodiments, the offline merchant server 118 can further include a controller (not shown) monitoring a point of sale (POS) input terminal 120. In some embodiments, the POS terminal 120 can be configured to support both contactless (e.g., radio) and direct (e.g., electrical conduction) transactions and/or data exchange including, for example, near field communication (NFC) device readers, credit/debit card readers, smart card readers, radio frequency identification (RFID) tag readers, online account based systems and so on. In some embodiments, the offline merchant server 118 can connect to a merchant bank account via the payment gateway server 108 to facilitate transfer of funds during a consumer transaction (not shown).

In some embodiments, the online marketplace server 112 and the offline merchant server 118 can connect to the products and services database 116 directly. In some embodiments, the online marketplace server 112 and the offline merchant server 118 can connect to the products and services database 116 via a validation server (not shown). In some embodiments, a consumer can select an item for purchase. In some embodiments, the item can be a product and/or services in the products and services database 116. In some embodiments, the system 100 can include products and services database 116. In some embodiments, products and services database 116 can store information including standard price and the discount threshold on all the products and services listed on the online marketplace server 112 and offline merchant server 118. As used herein, the standard price can be the non-discounted retail price, for example. As used herein, the discount threshold can be a dollar amount or percentage of the standard price above which no further discount is offered. In some embodiments, the information stored on the products and services database 116 can include, but is not limited to, categories, names, description, images, pricing and discount threshold of the products and services offered to consumers. In some embodiments, the information from the products and services database 116 can be accessed over data network through network connections such as wide area network (WAN) (represented by all arrows in FIG. 1). In some embodiments, users can have access to the information contained in the products and services database 116 via the online marketplace server 112, the offline merchant server 118, or both. In some embodiments, information contained in the products and services database 116 can be filtered after mining and or searching the online marketplace server 112, the offline merchant server 118, or both for offerings after applying the discount thresholds as described. In some embodiments, filtration can include limiting the categories of products and services a user wants to browse e.g., clothing, catering, household goods, or electronics. In some embodiments, filtration can reduce the price range. In some embodiments, filtration can include limiting products and services to those in the loss to discount recovery range meaning filtering for those products which, if purchased, would offer e.g., about 100%, 95%, 90%, 85%, 80%, 75%, 70%, 65%, 60%, 55%, 50%, 45%, 40%, 35%, 30%, 25%, 20%, 15%, 10%, 5%, 3%, 2%, 1%, or any value or range between of loss recovery. In some embodiments, the computation server 122 can access all information including discount threshold from the products and services database 116 directly or via the validation server (not shown). As one of ordinary skill in the art would appreciate, in some embodiments, the products and services database 116 can be any type of storage device or storage medium such as hard disks, cloud storage, CD-ROMs, flash memory, DRAM and can also include a collection of devices (e.g., Redundant Array of Independent Disks (“RAID”)).

In some embodiments, the system 100 can include an index fund server 124. In some embodiments index fund server 124 can store electronic information regarding index funds, investment portfolios, collective investment schemes, and other individual and complied stocks, in which a consumer can invest savings and/or income through system 100. In some embodiments, the consumer can invest money (e.g., savings and/or income) through the consumer's communication device 102 that is configured to connect to the system 100 with the consumer account of the user (e.g., online account-based system). In some embodiments, the index fund server 124 can also connect to other investment schemes included but not limited to social conscious funds, exchange-traded funds (ETF), mutual funds, fund of funds (FOF), pre-constructed portfolios, and so on. In some embodiments, a consumer can invest in a pre-constructed index such as (S&P 500, DJIA, Nasdaq etc.). In some embodiments, the index fund server 124 can also connect to an electronic trading platform which enables consumers to invest in individual or fractional stocks instead of a collective index fund. Once a user chooses an investment option and transfers funds to it, the index fund server 124 can store this information in portfolio database 126 for the computation server 122 to access said investment information.

In some embodiments, the index fund server 124 can store the user's investment data in real-time or near real-time in the portfolio database 126. In some embodiments, once an investment has been made, the index fund server 124 can monitor the user's investment performance. In some embodiments, the index fund server 124 can monitor the user's investment performance in determined intervals. In some embodiments, the index fund server 124 can monitor the user's investment performance in determined intervals and store the user's investment performance data in real-time, near real-time in the portfolio database 126. In some embodiments, the information gathered by in index fund server 124 and stored in the portfolio database 126 can be used by the computation server 122 to calculate an offset amount. In some embodiments, the information gathered by in index fund server 124 and stored in the portfolio database 126 can be used by the computation server 122 to calculate a discount based on an offset amount in the event of loss on investment. These embodiments are discussed in greater detail below with FIGS. 2-3. In some embodiments, the index fund server 124 can monitor the investment performance in real-time, near real-time, or in determined intervals to help the computation server 122 calculate discount in the event of loss on investment. These embodiments are discussed in greater detail below with FIGS. 2-3. In some embodiments, the index fund server 124 can monitor and store information on portfolio database 126 regarding consumer's investment's performance over time. In some embodiments, index fund server 124 and portfolio database 126 reside on the same computing device. In some embodiments, index fund server 124 and portfolio database 126 reside on different computing devices.

In some embodiments, the system 100 can include a computation server 122. In some embodiments, computation server 122 can include a web-based operating system and/or a processor (not shown). In some embodiments, the computation server 122 can modulate the price of products and services as per investment performance (e.g., user investment performance data). In some embodiments, the computation server 122 can modulate the price of products and services as per investment performance data in real-time, near real-time, at determined intervals. As such, in some embodiments, the computation server can 122 access the index fund server 124, the portfolio database 126, the products and services database 116, and the data database 128. In some embodiments, the computation server 122 can access the portfolio information associated with the respective consumer account by reading the user's data from the portfolio database 126 after the security authentications and protocols. As discussed above, in some embodiments, the index fund server 124 can monitor at least one of the aforementioned investment options (pre-constructed index, fractional stocks, social conscious funds, etc.) and store changes in a user's consumer investment portfolio in the portfolio database 126. In some embodiments, the index fund server 124 can monitor at least one of the aforementioned investment options (pre-constructed index, fractional stocks, social conscious funds, etc.) in real-time, near real-time, at determined intervals and store changes in a user's consumer investment portfolio in the portfolio database 126.

In some embodiments, the computation server 122 can access the portfolio database 126 via the index fund server 124 to obtain any change in investment performance (as recorded by index fund server 124) in order to modulate the price of goods and services for a particular user based on that user's investment performance data, which is discussed in greater detail below with FIGS. 2-3. In some embodiments, the computation server 122 can execute a sequence of instructions that modulates the price of products on the investment-based merchant pricing platform 110 to match the real-time, near real-time, or interval determined fluctuation on the consumer's investments, which is discussed in greater detail below with FIGS. 2-3. In some embodiments, the computation server 122 can access the products and services database 116 through online marketplace server 112, the offline merchant server 118, or both, which stores, among other information, this discount threshold for an item (e.g., products and services). In some embodiments, the computation server 122 can indirectly access, through a validation server (not shown), the products and services database 116, which stores, among other information, the discount threshold for products and services.

In some embodiments, the system 100 can include computation server 122 configured to do as follows: identify an item for a user; access a consumer investment portfolio and a portfolio database 126 associated with a respective consumer account of the user; connect to an index fund server 124 that is linked to an electronic trading platform; determine an offset amount to be applied to the price of the item by analyzing, in real-time, a performance of the consumer investment portfolio associated with the respective consumer account; generating an updated price of the item for the user by applying the offset amount to the price of the item, the updated price of the item unique to the performance of the consumer investment portfolio; and transfer a payment from a consumer account to a merchant account if the user purchases the item.

In some embodiments, the item can include a good, service, product, or other purchasable entity. In some embodiments, the item can be listed in the products and services database 116.

In some embodiments an offset amount can be equal to the loss incurred on a consumer investment portfolio. In some embodiments, offset amount can be equal to the gained incurred on a consumer investment portfolio. In some embodiments, an offset amount can be the amount of profit or loss determined by process LTD 130 and/or process PPP 132 (discussed in FIGS. 2-3). In some embodiments, determining an offset amount to be applied to the price of an item can happen in real-time, near real-time, or at determined intervals.

In some embodiments, the updated price of the item can be the offset amount applied to the standard price of the item. In some embodiments, the updated price of the item can be the discounted price. In some embodiments, the updated price of the item can be unique to the performance of the consumer investment portfolio in that the updated price of the item is modulated in user specific manner according to performance of a user's investment portfolio performance.

In some embodiments, the computation server 122 can execute web-based applications, such as computing as offset amount to be applied to the price of an item, process LTD 130 or PPP 132, discussed in FIGS. 2-3.

Briefly, in some embodiments, if the consumer's investments suffer a loss, the computation server 122 can compute a discount value equal to the loss incurred on the consumer's investments and update, in real-time, near real-time, at determined intervals, the prices of all the products and services listed on investment-based merchant pricing platform 110. In some embodiments, these updated prices can be displayed on the consumer's device 102a-n. As discussed above, in some embodiments, the computation server can connect to the data database 128 to store availed discounts and or to recommend products and services to the user based on transaction history. In some embodiments, the computation server 122 can transfer a payment (e.g., funds) from consumer account to a merchant account if the user purchases the item. In some embodiments, in an event of the consumer making a purchase, the payment gateway server 108 facilitates the transfer of funds from the consumer's account to the merchant account (not shown).

In some embodiments, the system 100 can include a merchant server (not shown). The merchant server can be configured to access user investment performance data from the consumer investment portfolio. In some embodiments, the merchant server can be configured to access discount threshold data. In some embodiments, discount threshold data can also be stored on the products and services database 116. In some embodiments, discount threshold data can be stored on one or more merchant database (not shown). In some embodiments, the merchant server can be configured to determine a discount offer using the user investment performance data and the discount threshold data.

In some embodiments, the methods disclosed herein can further include accessing, by a merchant server (not shown), user investment performance data. In some embodiments, the methods disclosed herein can include accessing, by the merchant server, discount threshold data. In some embodiments, the discount threshold data can also be stored on the products and services database 116. In some embodiments, the methods disclosed herein can include determining, by the merchant server using the user investment performance data and the discount threshold data, a discount offer. In some embodiments, the discount offer can be, for example, equal to a user's loss on investment as determined by computing as offset amount to be applied to the price of an item, by process LTD 130 and/or process PPP 132. In some embodiments, the discount offer can be, for example, equal to about 100%, 95%, 90%, 85%, 80%, 75%, 70%, 65%, 60%, 55%, 50%, 45%, 40%, 35%, 30%, 25%, 20%, 15%, 10%, 5%, 3%, 2%, 1%, or any number or range between of the user's loss on investment. In some embodiments, the methods disclosed herein can include updating, by the merchant server (not shown), the price of a good or service. In some embodiments, the updated price of the good and/or service can be displayed on the investment-based merchant pricing platform 110. Thus, in some embodiments, the system 100 can offer merchants a way to effectively disburse discounts and/or promotions to users.

As a normal practice, consumers purchase goods or services from merchants at a standard price pre-determined by merchants. In some embodiments, consumers can pay a price which is discounted as compared to the standard price for the same product by the same merchant. In some embodiments, this discounted price can be determined in real-time, near-real time, at determined intervals by the computation server 122 after monitoring index fund performance of the consumer investment portfolio via the index fund server 124 and converting any losses on the consumer's investments into discounts on all the products and services listed on the investment-based merchant pricing platform 110. In some embodiments, the same discount can be applicable to all the products and services listed on the offline merchant server 118 accessed through the data network as well. In some embodiments, the computation server 122 can access the consumer investment portfolio performance information over data network through respective network connections, represented as solid line in FIG. 1. In some embodiments, these network connections can be wired or wireless and can be implemented using any known protocol (e.g., TLS/SSL/SCP etc.). In some embodiments, the data network can be any one of a global data network (e.g., the Internet), a regional data network, or a local area network. The data network can use common high-level protocols, such as TCP/IP and can include multiple networks of differing protocols connected through appropriate gateways. In some embodiments, the computation server 122 can evaluate the performance, e.g., profits and or loss on consumer investments and calculate the discounts, if any, for consumers. In some embodiments, in an event of a consumer transaction, these discounts can be availed by consumers on their purchased goods and services from the investment-based merchant pricing platform. In some embodiments, payment gateway server 108 facilitates the transmission of payment information from consumer devices C1 102a, C2 102b, and Cn 102n to the index fund server 124, offline merchant server 118, or online marketplace server 112 over data network, for example, via the Internet.

As previously mentioned in some embodiments, for consumer investment-based transaction system 100, which allows consumers to supplement the loss on their investments by availing discounts on products and services, consumers can be given an option to make the payment by utilizing funds in their consumer investment portfolio. In some embodiments, consumers can transfer funds from their respective consumer investment portfolio as payment for the products and services purchased to the merchant account associated with offline merchant server 118 or online marketplace server 112 via the payment gateway server 108 through the data network. Thus, in some embodiments, consumers can pay a discounted price for their need-based expenses by liquidating their investments.

In some embodiments, the systems and methods disclosed herein target consumers without existing investment portfolios in order to increase the overall percentage of active investors while simultaneously helping merchants selectively discount product prices for those consumers who suffer loss on their investments. Hence, in some embodiments, not only enabling more consumers to invest, but also providing user-specific data to merchants to increase their overall profitability offering selective discounts. In some embodiments, the system and methods disclosed can be an alternative to standard checking accounts.

Modulating Merchant Discount Data in a User Specific Manner

In some embodiments, modulating merchant discount data in a user specific manner can include the systems methods described herein wherein user specific modulation can include an updated price of an item unique to the performance of the consumer investment portfolio.

In some embodiments, the system 100 can include components such as a computation server 122 that can determine an offset amount to be applied to the price of an item by analyzing, in real-time, a performance of the consumer investment portfolio associated with the respective consumer account; generating an updated price of the item for the user by applying the offset amount to the price of the item, the updated price of the item unique to the performance of the consumer investment portfolio.

In some embodiments, the system and methods disclosed herein can further include the computation server 122 detecting a change in the performance of the consumer investment portfolio prior to payment from the user; determining, by the computation server, a second offset amount based on the change in the performance; based on the determining, generating, by the computation server 122, a second updated price of the item for the user by applying the second offset amount to the price of the item, the second updated price unique to the change in performance of the consumer investment portfolio.

In some embodiments, the system and methods disclosed herein can further include the computation server 122 accessing a second consumer investment portfolio and a second portfolio database associated with a second consumer account of a second user; determining, by the computation server, a second offset amount to be applied to the price of the item by analyzing, in real-time, a performance of the second consumer investment portfolio associated with the second consumer account; generating, by the computation server 122, a second updated price of the item for the second user by applying the second offset amount to the price of the item, the second updated price of the item unique to the performance of the second consumer investment portfolio, the second updated price of the item different than the first updated price of the item.

In some embodiments, determining, by the computation server 122, the offset amount to be applied to the price of the item by analyzing, in real-time, the performance of the consumer investment portfolio associated with the respective consumer account can include process LTD 130 and/or process PPP 132.

FIG. 2 is a flowchart of process LTD 130 in accordance with certain embodiments. FIG. 2 illustrates a method of determining the offset amount to be applied to the price of an item. In some embodiments, the method of determining the offset amount to be applied to the price of an item can include the loss to discount (LTD) process 130 executed by the computation server 122. Process LTD 130

can be a web-based application. In some embodiments, process LTD 130 can include various program modules including routines, programs, objects, components, data structures, and so on that perform particular tasks or implement particular abstract data types. In some embodiments, in a distributed computing environment, these modules can be located in both local and remote storage devices including memory storage devices.

At block 202, back end computing system accesses user data. For example, computation server 122 can access index fund server 124, which can be granted access to portfolio database 126. From portfolio database 126, payment gateway server 108 may retrieve information related to the user's transfer of funds to an investment, for example, an index fund. In some embodiments, such retrieval of information may be performed via one or more APIs. In some embodiments, at block 202 computation server 122 can access any transfer of funds to the index fund server 124. In some embodiments, once a connection is established, index fund server 124 intercepts the transmitted information. In some embodiments, a consumer authorizes index fund server 124 to intercept payment information from consumer device C1 102a, C2 102b, Cn 102n in real-time, after transmission. In some embodiments, index fund server 124 can also periodically poll payment gateway server 108 for recent payment transactions. Client/server-based polling in network computing environments is well understood and appreciated.

At block 204 back end computing system accesses initial user data. For example, computation server 122 can access index fund server 124, which can have access to portfolio database 126. From portfolio database 126, payment gateway server 108 may retrieve information related to the user's transfer of funds to an investment, for example, an index fund. In some embodiments, such retrieval of information may be performed via one or more APIs. Index fund server 124 (in real-time or near real-time, by a determined interval) assigns an invested principal pegged value to the consumer account associated with the consumer device C1 102a, C2 102b, Cn 102n, where invested principal pegged value is equal to the amount of funds consumer transferred to the index fund. In some embodiments, the method of determining the offset amount of the item can include the computation server 122 assigning an invested principal pegged value to the respective consumer account.

At block 206, back end computing system captures user data over time. For example, computation server 122 can access index fund server 124, which can have access to portfolio database 126. In portfolio database 126, index fund server 124 store consumer investment portfolio performance. In some embodiments, such storage of information may be performed via one or more APIs or any other suitable means. In some embodiments, computation server 122 can reach out to index fund server 124 to analyze data stored in portfolio database 126. In some embodiments, computation server 122 can analyze in real-time, near real-time or in determined intervals a performance of the consumer investment portfolio associated with the respective consumer account. In some embodiments, computation server 122 tracks invested principal's performance to account for real time profits or losses on the consumer's invested principal. In some embodiments, real-time can be when the user initiates the command, at a fixed interval, or any other time.

At block 208, back end computing system determines user data at designated time. For example, computation server 122 can access index fund server 124, which can have access to portfolio database 126. From index fund server 124, computation server can retrieve consumer investment portfolio performance at a designated time. In some embodiments, such retrieval of information may be performed via one or more APIs or any other suitable means. Designated time can be, for example, that index fund server 124 can determine the current value of consumer's invested principal upon user's command or at a determined interval.

At block 210, back end computing system determines offset amount. For example, computation server 122 can access index fund server 124, which can have access to portfolio database 126. From index fund server 124 from portfolio database 126, computation server 122 can retrieve invested principal pegged value (determined at 204), invested principal's current value (determined at block 208) and computation server 122 can subtract the later from the former. In some embodiments, such retrieval of information may be performed via one or more APIs or any other suitable means. In some embodiments, computation server 122 computes any loss on consumer's investments by calculating the difference between pegged value and current value of consumer's invested principal in real-time or near real time.

At block 212, back end computing system determines a discount. Computation server 122 can assign a discount value equal to the calculated loss to the consumer account. In some embodiments, the computation server 122 can assign a discount value equal to the loss on the invested principal pegged value.

At block 214, back end computing system determines updated price of an item unique to performance of consumer investment portfolio. For example, computation server 122 can access online marketplace server 112 and offline merchant server 118, which can access products and service database 116. From products and services database, online marketplace server 112 and/or offline merchant server 118 can retrieve discount threshold data for products and services listed. From the online marketplace server 112 and/or offline merchant server 118, computation server can retrieve discount threshold data and computation server 122 can compare the offset amount to a discount threshold for each product and service listed. In some embodiments, such retrieval of information may be performed via one or more APIs or any other suitable means. In some embodiments, the computation server 122 can apply the discount value at most up to the discount threshold for each product and service, which is stored on the products and services database 116. In some embodiments, if the computed discount is less than or equal to discount threshold mentioned for each product or service, process LTD 130 may apply the discount at most up to discount threshold value for each product or service and the computation server 122 updates the prices of all the products and services listed on the investment-based merchant pricing platform 110 for the consumer.

At block 216, client side system displays the updated prices. For example, consumer communication devices 102 can access investment-based merchant pricing platform 110. From investment-based merchant pricing platform 110, consumer communication devices 102 can display updated prices. Display communication onto the consumer devices C1 102a, C2 102b, Cn 102n using server push or comparable publish/subscribe-based data network communication.

Hypothetically, if a user invested 1000$ and, after a while, incurred a loss of 100$, executing process LTD 130, computation server 122 could display the updated prices of all the listed products and services on marketplace by applying discounts up to 100$, as governed by the threshold discount mentioned for items (listed on products and services database 116) on the user's device 102. In some embodiments, executing process LTD 130 computation server 122 returns to monitor any further change in user's invested principal by evaluating the user investment performance data and comparing it to the invested principal's pegged value (block 206).

As explained above, in some embodiments, the system 100 can obtain data and modulate prices online or offline. Online obtaining means that the system receives a real-time message that carries a command, and then executes the command in real-time or near real-time after obtaining the command. In some embodiments, for example, the system 100 can receive a command from a user device 102n to initiate process LTD 130, the computation server 122 then executes process LTD 130 and updates the prices on the user's device.

Offline obtaining means that the system synchronizes data regularly, and processes synchronized data offline after obtaining the data. For example, in some embodiments, the computation server 122 synchronizes the data at 6:00 am every day. When data is processed offline, stability of online system can be ensured, data processing complexity can be reduced, and reliability of a data processing result can be ensured.

FIG. 3 is a flowchart of process PPP 132 in accordance with certain embodiments. FIG. 3 illustrates a method of determining the offset amount to be applied to the price of an item. In some embodiments, the method of determining the offset amount to be applied to the price of an item can include the Peak Profit Pegging Process (PPP) 132 executed by the computation server 122. In some embodiments, the Peak Profit Pegging Process (PPP) 132 can comprise various program modules including routines, programs, objects, components, data structures, and so on that perform particular tasks or implement particular abstract data types. In some embodiments, in a distributed computing environment, these modules can be located in both local and remote storage devices including memory storage devices.

At block 302, back end computing system accesses user data. For example, computation server 122 can access index fund server 124, which can be granted access to portfolio database 126. From portfolio database 126, payment gateway server 108 may retrieve information related to the user's transfer of funds to an investment, for example, an index fund. In some embodiments, such retrieval of information may be performed via one or more APIs. In some embodiments, at block 302 computation server 122 can access any transfer of funds to the index fund server 124. In some embodiments, once a connection is established, index fund server 124 intercepts the transmitted information. In some embodiments, a consumer authorizes index fund server 124 to intercept payment information from consumer device C1 102a, C2 102b, Cn 102n in real-time, after transmission. In some embodiments, index fund server 124 can also periodically poll payment gateway server 108 for recent payment transactions. Client/server-based polling in network computing environments is well understood and appreciated.

At block 304, back end computing system accesses initial user data. For example, computation server 122 can access index fund server 124, which can have access to portfolio database 126. From portfolio database 126, payment gateway server 108 may retrieve information related to the user's transfer of funds to an investment, for example, an index fund. In some embodiments, such retrieval of information may be performed via one or more APIs. Index fund server 124 (in real-time or near real-time, by a determined interval) assigns an invested principal pegged value to the consumer account associated with the consumer device C1 102a, C2 102b, Cn 102n, where invested principal pegged value is equal to the amount of funds consumer transferred to the index fund. In some embodiments, the method of determining the offset amount of the item can include the computation server 122 assigning an invested principal pegged value to the respective consumer account.

At block 306, back end computing system accesses user data at peak. For example, computation server 122 can access index fund server 124, which can have access to portfolio database 126. In portfolio database 126, index fund server 124 store consumer investment portfolio performance. In some embodiments, such storage of information may be performed via one or more APIs or any other suitable means. In some embodiments, computation server 122 can reach out to index fund server 124 to analyze data stored in portfolio database 126. In some embodiments, computation server 122 can analyze in real-time, near real-time or in determined intervals a performance of the consumer investment portfolio associated with the respective consumer account. In some embodiments, computation server 122 tracks invested principal's performance to account for real time profits or losses on the consumer's invested principal. In some embodiments, real-time can be when the user initiates the command, at a fixed interval, or any other time. In some embodiments, an enhanced invested principal's pegged value equal is to the consumer's invested principal value at the peak profit gain. The consumer's invested principal at peak profit gain is determined by the computation server 122 in communication with the index fund server 124 and the portfolio database 126, which, in some embodiments, can assign highest value of user data i.e., enhanced principal pegged value to a respective consumer account.

At block 308, back end computing system captures user data over time. For example, computation server 122 can access index fund server 124, which can have access to portfolio database 126. In portfolio database 126, index fund server 124 store consumer investment portfolio performance. In some embodiments, such storage of information may be performed via one or more APIs or any other suitable means. In some embodiments, computation server 122 can reach out to index fund server 124 to analyze data stored in portfolio database 126. In some embodiments, computation server 122 can analyze in real-time, near real-time or in determined intervals a performance of the consumer investment portfolio associated with the respective consumer account. In some embodiments, computation server 122 tracks invested principal's performance to account for real time profits or losses on the consumer's invested principal. In some embodiments, real-time can be when the user initiates the command, at a fixed interval, or any other time.

At block 310 back end computing system determines user data at designated time. For example, computation server 122 can access index fund server 124, which can have access to portfolio database 126. From index fund server 124, computation server can retrieve consumer investment portfolio performance at a designated time. In some embodiments, such retrieval of information may be performed via one or more APIs or any other suitable means. Designated time can be, for example, that index fund server 124 can determine the current value of consumer's invested principal upon user's command or at a determined interval. In some embodiments, computation server 122 determines the current value of consumer's invested principal based on the profits or loss on consumer's invested principal.

At block 312, back end computing system determines offset amount. For example, computation server 122 can access index fund server 124, which can have access to portfolio database 126. From index fund server 124 from portfolio database 126, computation server 122 can retrieve enhanced principal pegged value (determined at 306), invested principal's current value (determined at block 310) and computation server 122 can subtract the later from the former. In some embodiments, such retrieval of information may be performed via one or more APIs or any other suitable means. In some embodiments, computation server 122 computes any loss on consumer's investments by calculating the difference between enhanced principal pegged value and current value of consumer's invested principal in real-time or near real time.

At block 316, back end system incrementally processes offset amount. For example, computation server 122 can access index fund server 124, which can have access to portfolio database 126. From index fund server 124 from portfolio database 126, computation server 122 can retrieve enhanced principal pegged value (determined at 306), invested principal's current value (determined at block 310) and computation server 122 can subtract the later from the former. In some embodiments, such retrieval of information may be performed via one or more APIs or any other suitable means. In some embodiments, computation server 122 computes any loss on consumer's investments by calculating the difference between enhanced principal pegged value and current value of consumer's invested principal in real-time or near real time. When consumer's investment is in profit, computation server 122 updates the enhanced invested principal's pegged value (value determined at block 306) by adding the computed profits to the previous enhanced invested principal's pegged value. This process enables consumers to take advantage of the peak profit gain on their investments by storing the profits every time the investment reaches a new high in a time period. In some embodiments, a time period can be the duration of time beginning from when the funds are invested and ending when the funds are retrieved. For example, if a user invested funds on the first of a month and retrieved funds on the 29′ of a month, the time period would be 28 days. Because, in some embodiments, discounts on products and services are calculated based on the difference between enhanced invested principal pegged and current values, this way the consumers can benefit from the peak value of their investments in terms of more discounts.

At block 314, back end computing system determines a discount. If computation server 122 computes investments are in loss, computation server 122 computation server 122 can assign a discount value equal to the calculated loss to the consumer account. In some embodiments, the computation server 122 can assign a discount value equal to the loss on the enhanced principal pegged value.

At block 318, back end computing system determines updated price of an item unique to performance of consumer investment portfolio. For example, computation server 122 can access online marketplace server 112 and offline merchant server 118, which can access products and service database 116. From products and services database, online marketplace server 112 and/or offline merchant server 118 can retrieve discount threshold data for products and services listed. From the online marketplace server 112 and/or offline merchant server 118, computation server can retrieve discount threshold data and computation server 122 can compare the offset amount to a discount threshold for each product and service listed. In some embodiments, such retrieval of information may be performed via one or more APIs or any other suitable means. In some embodiments, the computation server 122 can apply the discount value at most up to the discount threshold for each product and service, which is stored on the products and services database 116. In some embodiments, if the computed discount is less than or equal to discount threshold mentioned for each product or service, process PPP 132 may apply the discount at most up to discount threshold value for each product or service and the computation server 122 updates the prices of all the products and services listed on the investment-based merchant pricing platform 110 for the consumer.

At block 320, client side system displays the updated prices. For example, consumer communication devices 102 can access investment-based merchant pricing platform 110. From investment-based merchant pricing platform 110, consumer communication devices 102 can display updated prices. Display communication onto the consumer devices C1 102a, C2 102b, Cn 102n using server push or comparable publish/subscribe-based data network communication.

It is worthwhile to note that, in some embodiments, the system 100 can obtain data and modulate prices online or offline. Online obtaining means that the system receives a real-time message that carries a command, and then executes the command in real-time or near real-time after obtaining the command. In some embodiments, for example, the system 100 can receive a command from a user device 102n to initiate process LTD 130, the computation server 122 then executes process LTD 130 and updates the prices on the user's device.

Offline obtaining means that the system synchronizes data regularly, and processes synchronized data offline after obtaining the data. For example, in some embodiments, the computation server 122 synchronizes the data at 6:00 am every day. The data on includes process LTD 130. When data is processed offline, stability of online system can be ensured, data processing complexity can be reduced, and reliability of a data processing result can be ensured.

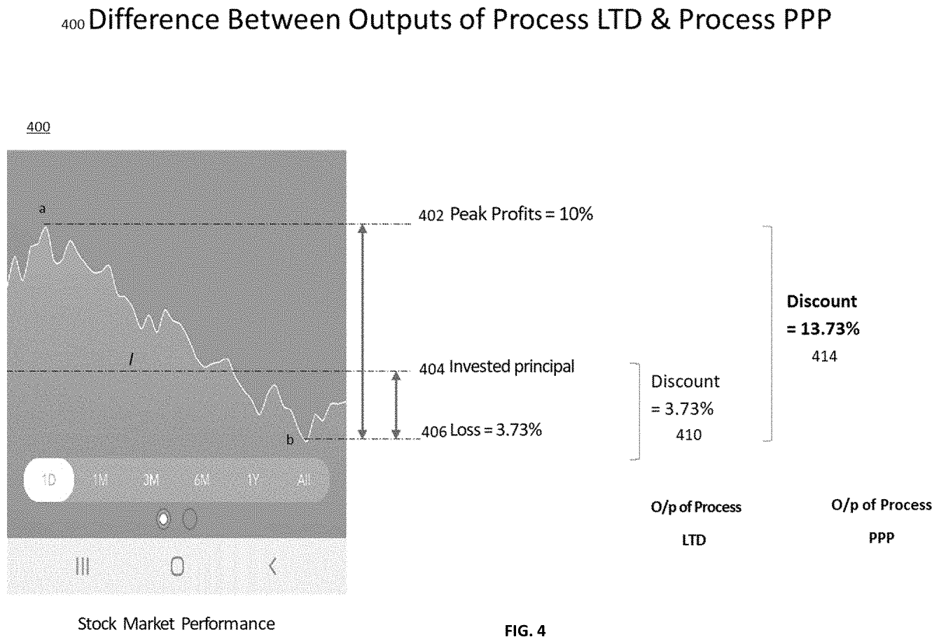

FIG. 4 is an example of difference in functional output between two processes PPP and LTD 400. Line l 404 represents the actual invested principal which the consumer invested. In the hypothetical situation, after a while, the consumer's invested principal 404 reached a peak profit gain of 10% 402, as represented by point a 402 in the graph. Later, the consumer's invested principal 404 declined in profits and incurred a loss of −3.73% 406, as represented by point b 406. As shown in FIG. 4, executing process LTD 130, computation server 122 will calculate the loss on investment by taking the difference between invested principal's pegged value equal to the actual consumer invested principal and current value (i.e., value at point b) thus computing the discount equal to 3.73% 410. However, executing process PPP 132, computation sever 122 will calculate the difference by taking into account the enhanced invested principal's pegged value 402 which is equal to the consumer's invested principal's value at the time of peak profit gain (i.e., value at point a) 402 and thus compute the discount to be 13.73% 414, as shown in FIG. 4. At one time, a consumer can opt for one or neither of either process PPP 132 or process LTD 130. Since process PPP 132 and process LTD 130 are two different value offerings, in some embodiments process PPP 132 can be priced higher than process LTD 130.

Implementations of the current subject matter can include, without limitation, systems and methods consistent with the disclosed methodology and processes, including one or more features and articles that comprise a tangibly embodied machine or computer-readable medium operable to cause one or more machines (e.g., computers, processors, etc.) to result in operations disclosed herein, by way of, for example, logic code or one or more computing programs that cause one or more processors to perform one or more of the disclosed operations or functionalities. The machines can exchange data, commands or other instructions via one or more connections, including but not limited to a connection over a network.

The details of one or more variations of the subject matter described herein are set forth in the accompanying drawings and the description below. Other features and advantages of the subject matter described herein will be apparent from the description and drawings, and from the claims. The disclosed subject matter is not, however, limited to any particular embodiment disclosed.

### EXAMPLES

In some embodiments, the system disclosed herein can include the computation server 122 configured to offer an interest free loan to a user. The loan can be structured in order to encourage voluntary loan repayment from the user in order for the user to regain access to the loss management services (discounts proportional to loss on investment, applying earned profits on investments to purchases, etc.) of the investment-based merchant pricing platform 110 as soon as possible. In some embodiments, the loan amount can depend upon a user's transaction history of purchases made through the investment-based merchant pricing platform 110. In some embodiments, the loan amount can be determined by dividing the earned commission with the ongoing interest rate in the market. The earned commission can be a percent of each transaction. The commission percent can be 0.1%, 0.2%, 0.3%, 0.4%, 0.5%, 1%, 2%, 3%, 4%, 5%, 10% or any number or range between. In some embodiments, the earned commission made on every purchase that a user makes through the investment-based merchant pricing platform 110 can replace interest charges and enable the system to offer interest free loans. In some embodiments, the investment-based merchant pricing platform 110 can display only non-discounted goods and services until the repayment of the loan. In some embodiments, the user repays the loan using investments, profits, and or personal funds. If the user's investment is at loss while the user has an outstanding loan, the system 100 can be configured to remove and/or withhold the offset amount from the price of an item (and/or freeze process LTD 130 and PPP 132) and thereby offer no discount on goods and services listed on the investment-based merchant pricing platform 110. If the user's investment is in profit while the user has an outstanding loan, the system can be configured to offer no discount on goods and services listed on the investment-based merchant pricing platform 110 and to collect profits from the user's investments. In some embodiments, when the user's investment is in profit, the system 100 can be configured to collect 0.1%, 0.2%, 0.3%, 0.4%, 0.5%, 0.6%, 0.7%, 0.8%, 0.9%, 1%, or any number or range between of the profits on investment. In other embodiments, when the user has taken out a loan, the system can be configured to facilitate profit-sharing between an entity operating the system and the user. In some embodiments, the systems disclosed herein can be configured to collect 20%, 25%, 30%, 40%, 45%, 50%, or any number or range between of the profits on the user's investment until the loan is repaid. In some embodiments, the profit-sharing feature can be independent of loan repayment.

In some embodiments, the system disclosed herein can include the computation server 122 configured to transfer discounts and or profits toward a user's savings goal or goals. In some embodiments, a savings goal can include travel, education, car, home, medical, or any other user-specified savings goal or goals. In some embodiments, the computation server 122 be configured to transfer discounts offered on the investment-based merchant pricing platform 110 to savings goals and then displaying, to a user, the standard price for an item (e.g., a good or service listed in the investment-based merchant pricing platform 110). In some embodiments, the computation server 122 can be configured to facilitate transfer of a user's profits on investment to a savings goal. In some embodiments, computation server 122 can be configured to track savings goals, accumulated discounts, or transferred profits in the data database 128.

In some embodiments, the system disclosed herein can include the computation server 122 configured to support an investment-based discount card. The investment-based discount card can be accepted by one, a plurality, or all partner merchants of the investment-based merchant pricing platform 110. In some embodiments, the investment-based discount card can be accepted by one, a plurality, or all partner merchants online. In some embodiments, the investment-based discount card can be accepted by one, a plurality, or all partner merchants offline. In some embodiments, the investment-based discount card can be accepted by one, a plurality, or all partner merchants online and offline. In some embodiments, all discounts and profits on a consumer investment portfolio associated with a particular user account can be accumulated, by the computation server 122, into one investment-based discount card. The investment-based discount card can hold discounts for a particular user in correspondence with a consumer investment portfolio associated with a particular user. In some embodiments, the investment-based discount card can be configured to hold discounts equal to losses in a consumer investment portfolio as determined by the computation server 122 determining the offset amount or executing process LTD 130 or PPP 132, but not exceeding a discount threshold set by brick-and-mortar stores of partner merchants. In some embodiments, the investment-based discount card can be configured to hold profits of a consumer investment portfolio to use as payment in transaction. In some embodiments, the investment-based discount card can hold both discounts and profits. In some embodiments, a user can then use this investment-based discount card to avail applicable discounts on purchases at partner merchants any time and any place of the user's choosing. In some embodiments, this investment-based discount card takes the place of carrying multiple discount cards for multiple merchants, allowing a user to carry one card and avail discounts at multiple merchants.

Another embodiment provides the system configured to mitigate losses on real property sold at a loss. In some embodiments, a user can be eligible for this feature if the user sells property at a price that is less than the price, adjusted for inflation, that the user initially paid for said property. In some embodiments, the user can receive supplemental discounts equivalent to the user's loss on property sale. The user can redeem these discounts on regular spending through partners on the investment-based merchant pricing platform 110 up to threshold on the discounts.

In another embodiment, the system can be configured to mitigate losses on wage loss due to layoff, furlough, pay cut, or other decreases in income. In some embodiments, the system 100 can have access to information regarding a user's income such a by linking back account or providing documents like income statements and pay stubs. In some embodiments, the system 100 can calculate decline in a user's income over a period of time after the initial income loss. In some embodiments, the system 100 can apply discounts on the investment-based merchant pricing platform 110 to users who have experienced income loss. In some embodiments, the system 100 can utilize algorithms to calculate discounts offered to each user so situated.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, can readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing illustrative embodiments, it is understood that the present disclosure has been made only by way of example, and that numerous changes in the details of implementation of the disclosed subject matter can be made without departing from the spirit and scope of the disclosed subject matter.

1. A method comprising:
identifying, by a computation server, an item for a user;
accessing, by the computation server, a consumer investment portfolio and a portfolio database associated with a consumer account of the user;
determining, by the computation server, an offset amount to be applied to a price of the item by analyzing, in real-time, a performance of the consumer investment portfolio associated with the respective consumer account of the user; generating, by the computation server, an updated price of the item for the user by applying the offset amount to the price of the item, the updated price of the item unique to the performance of the consumer investment portfolio; and
transferring, by a payment gateway server, a payment from the consumer account to a merchant account if the user purchases the item.

2. The method of claim 1, further comprising:
detecting, by the computation server, a change in the performance of the consumer investment portfolio prior to payment from the user;
determining, by the computation server, a second offset amount based on the change in the performance; and
based on the determining, generating, by the computation server, a second updated price of the item for the user by applying the second offset amount to the price of the item, the second updated price unique to the change in performance of the consumer investment portfolio.

3. The method of claim 1, further comprising:
accessing, by the computation server, a second consumer investment portfolio and a second portfolio database associated with a second consumer account of a second user;
determining, by the computation server, a second offset amount to be applied to the price of the item by analyzing, in real-time, a performance of the second consumer investment portfolio associated with the second consumer account; and
generating, by the computation server, a second updated price of the item for the second user by applying the second offset amount to the price of the item, the second updated price of the item unique to the performance of the second consumer investment portfolio, the second updated price of the item different than the first updated price of the item.

4. The method of claim 1, wherein determining, by the computation server, the offset amount to be applied to the price of the item by analyzing, in real-time, the performance of the consumer investment portfolio associated with the respective consumer account comprises:
assigning, by the computation server, an invested principal pegged value to the respective consumer account;
computing, by the computation server, a loss on the invested principal pegged value;
assigning, by the computation server, a discount value equal to the loss on the invested principal pegged value;
comparing the discount value to a discount threshold for each product and service listed in an investment-based merchant pricing platform; and
applying the discount value at most up to the discount threshold for each product and service, which is stored on a products and services database.

5. The method of claim 1, wherein determining, by the computation server, the offset amount to be applied to the price of the item by analyzing, in real-time, the performance of the consumer investment portfolio associated with the respective consumer account comprises:
assigning, by the computation server, an enhanced principal pegged value to the respective consumer account;
computing, by the computation server, a loss on the enhanced principal pegged value;
assigning, by the computation server, a discount value equal to the loss on the enhanced principal pegged value;
comparing the discount value to the discount threshold for each product and service listed in the investment-based merchant pricing platform; and
applying the discount value at most up to the discount threshold for each product and service, which is stored on the products and services database.

6. The method of claim 1, further comprising the computation server updating the price of one or more products or services listed on the investment-based merchant pricing platform comprises;
displaying the discount value equal to the loss on the enhanced principal pegged value or the discount value equal to the loss on the invested principal pegged value on a graphical user interface; and
displaying the updated price of one or more products or services listed on the investment-based merchant pricing platform that does not exceed the discount threshold for each product and service, which is stored on the products and services database.

7. A system comprising;
a computation server configured to perform as follows:
identifying an item for a user;
accessing a consumer investment portfolio and a portfolio database associated with a respective consumer account of the user;
connecting to an index fund server that is linked to an electronic trading platform; and
determining an offset amount to be applied to a price of the item by analyzing, in real-time, a performance of the consumer investment portfolio associated with the respective consumer account; generating an updated price of the item for the user by applying the offset amount to the price of the item, the updated price of the item unique to the performance of the consumer investment portfolio; and
a payment gateway server transferring a payment from a consumer account to a merchant account if the user purchases the item.

8. The system of claim 7, further comprising transferring a payment from a consumer account to a merchant account if a consumer makes a purchase on an investment-based merchant pricing platform.

9. The system of claim 8, wherein the investment-based merchant pricing platform contains an online marketplace server, an offline merchant server, one or more point of sale (POS) terminals, and a products and services database.

10. The system of claim 7, wherein determining the offset amount to be applied to the price of the item by analyzing, in real-time, the performance of the consumer investment portfolio associated with the respective consumer account comprises:
the computation server,
connecting to the portfolio database;
assigning an invested principal pegged value to the respective consumer account;
computing a loss on the invested principal pegged value;
assigning, by the computation server, a discount value equal to the loss on the invested principal pegged value;
comparing the discount value to a discount threshold for each product and service listed in the investment-based merchant pricing platform; and
applying the discount value at most up to the discount threshold for each product and service, which is stored on the products and services database.

11. The system of claim 7, wherein determining, by the computation server, the offset amount to be applied to the price of the item by analyzing, in real-time, the performance of the consumer investment portfolio associated with the respective consumer account comprises:
the computation server,
connecting to the portfolio database;
assigning an enhanced principal pegged value to the respective consumer account;
computing a loss on the enhanced principal pegged value;
assigning a discount value equal to the loss on the enhanced principal pegged value;
comparing the discount value to the discount threshold for each product and service listed in the investment-based merchant pricing platform; and
applying the discount value at most up to the discount threshold for each product and service, which is stored on the products and services database.

12. The system of claim 7, further comprising the computation server updating the price of one or more products or services listed on the investment-based merchant pricing platform comprises;
displaying the offset amount to be applied to the price of an item on a graphical user interface, and
displaying the updated price of one or more products or services that does not exceed a pricing and discount threshold for each product or service, which is stored on the products and services database.
